(19) United States
(12) Patent Application Publication
(10) Pub. No.: US 2013/0215273 A1
(43) Pub. Date: Aug. 22, 2013

(54) TRAFFIC ENFORCEMENT SYSTEM AND METHODS THEREOF

(71) Applicant: SaferPlace, Ltd., (US)

(72) Inventors: Uri Kareev, Tel Aviv (IL); Ari Schrieber, Ramat Gan (IL); Ori Berger, New York, NY (US); Hila Kareev, Tel Aviv (IL)

(73) Assignee: SaferPlace, Ltd., Tel Aviv (IL)

(21) Appl. No.: 13/849,670

(22) Filed: Mar. 25, 2013

Related U.S. Application Data
(63) Continuation of application No. PCT/IL2011/000755, filed on Sep. 25, 2011.

(51) Int. Cl. H04N 7/18

(52) U.S. Cl. CPC H04N 7/183
USPC 348/149

(57) ABSTRACT

An apparatus for monitoring and reporting suspect traffic violations is provided. The Apparatus comprises at least one video camera for capturing a video clip of a suspect traffic violation by an offending vehicle; a processor coupled to the at least one video camera, the processor configured to detect the suspect traffic violation based on a particular set of traffic violations and definitions of triggering events; and an interface to a network for reporting the detected suspect traffic violation.

### CROSS-REFERENCE TO RELATED APPLICATIONS

This application is a continuation application of an International Application No. PCT/IL2011/000755 having an international filing date of Sep. 25, 2011. This application also claims priority from U.S. provisional patent application No. 61/386,528 filed on Sep. 26, 2010, from U.S. provisional patent application No. 61/386,530 filed on Sep. 26, 2010, and from U.S. provisional patent application No. 61/508,644 filed on Jul. 17, 2011, the contents of all of which are incorporated herein by reference in their entirety.

### TECHNICAL FIELD

The present invention relates generally to traffic, moving and/or parking monitoring systems, and more specifically to a system for detecting and monitoring of the occurrence of traffic violations and providing respective video and still photographic evidence of the violations.

### BACKGROUND

Camera-based traffic monitoring systems are deployed by law enforcement agencies and municipalities to enforce traffic, moving and/or parking, laws in an attempt to modify unsafe driving behavior and illegal parking. Although video footage has been used for identification and prosecution of vehicles in violation of traffic laws, prior art solutions cover a low percentage of all traffic violations due to the complexity involved in identifying violations such as lane cutting, unlawful lane crossing, crossing of white lines, blocking a junction, improperly using a public transportation lane, or general reckless driving, as well as parking violations such as blocking a bus stop, parking in a place that obstructs view of a junction, and otherwise not complying with parking regulations. Furthermore, prior art solutions are generally static wherein the cameras are affixed in a predetermined location filming a predetermined path in order to locate a predetermined singular type of traffic or parking violation.

Therefore, in view of the deficiencies of the prior art, a system that identifies a higher percentage of traffic violations, and that would be flexibly deployable and efficient to operate, would be advantageous.

### BRIEF DESCRIPTION OF THE DRAWINGS

The subject matter that is regarded as the invention is particularly pointed out and distinctly claimed in the claims at the conclusion of the specification. The foregoing and other objects, features, and advantages of the invention will be apparent from the following detailed description taken in conjunction with the accompanying drawings.

FIG. 1 is a schematic diagram of a system in accordance with an embodiment of the invention.

FIG. 2 is a flowchart of the configuration of a system according to an embodiment of the invention.

FIG. 3 is a flowchart of the capture mode of a system according to an embodiment of the invention.

FIG. 4 is a flowchart of the citation mode of a system according to an embodiment of the invention.

### DETAILED DESCRIPTION

The embodiments disclosed herein are only examples of the many possible advantageous uses and implementations of the innovative teachings presented herein. In general, statements made in the specification of the present application do not necessarily limit any of the various claimed inventions. Moreover, some statements may apply to some inventive features but not to others. In general, unless otherwise indicated, singular elements may be in plural and vice versa with no loss of generality. In the drawings, like numerals refer to like parts through several views.

Certain exemplary embodiment disclosed herein include a system and methods thereof for defining, monitoring and reporting incidences of potential traffic violations, motion or parking, utilizing at least video clips thereof, and as necessary still images, are described. The system is efficient in evidence detection and collection for the purpose of off-line ticket generation respective of traffic violations. The system monitors various types of traffic violation defined for a particular location or instance and which are usually complex to track. The system maybe stationary, installed, for example, on a pole, or mobile, installed for example on a patrolling vehicle, or carried by a person such as a police officer or a traffic warden. In one embodiment, the system can also be used for real-time ticketing as well as dispatching a notification to a registered owner of a vehicle.

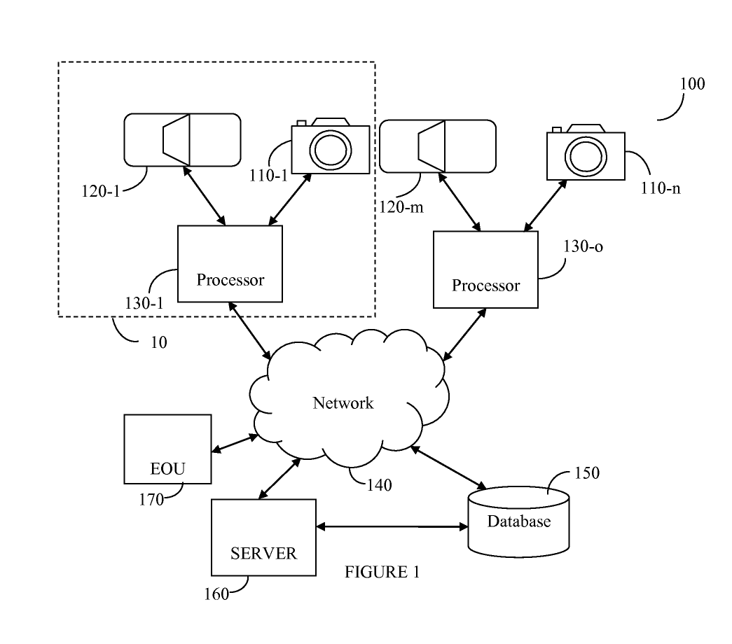

Reference is made to FIG. 1 where an exemplary and non-limiting block diagram 100 of a basic system according to one embodiment is shown. The system 100 comprises one or more subsystems 10, each subsystem 10 comprising at least a camera, for example video camera 120-1, potentially one or more cameras, for example still camera 110-1, and one or more processors, for example, processor 130-1. It should be understood therefore that there may be systems that do not include still cameras as long as the video cameras are able to provide sufficiently high-resolutions to enable legally acceptable enforcement standards.

Each subsystem 10 may be independently configured to monitor traffic violations that are specific to the position in which the subsystem 10 is located. This is done be defining the kinds of violations that the subsystem 10 can identify from the data stream from a video camera 120-1. If a potential violation is detected, sufficiently high-resolution evidence of the violating vehicle which is sufficient to enable identification of the vehicle is captured either from a high resolution video stream or from a still camera. The identification of the violation is performed by series of instructions that are executed by each of the processors 130-1 or 130-o. Such instructions that are stored in memory (not shown) coupled to the processor 130 (or in one embodiment integrated therein) enable detection and monitoring traffic violations such as, but not limited to, blocking a junction, lane cutting, lane-to-lane crossing while disturbing traffic, crossing over white lines, driving on the road shoulder, not keeping to the right of the road, dangerous overtaking, tailgating, i.e., driving too close to a vehicle in front of another vehicle, lane blocking, not yielding when so required, not giving the right of way, overtaking from the right when not allowed, running a red light, school bus overtaking, speeding by a predefined threshold speed over the speed limit, failing to maintain safe distance from other vehicles, crossing a railroad crossing when an indication of a nearing train is active, failing to slow or stop at a pedestrian crossing, illegal parking, and so on and so forth.

Similarly, such instructions enable detection and monitoring of parking violations, such as parking or stopping in a restricted area, (such as a no parking zone or a no stopping zone), parking on the curbside, parking on a pedestrian crosswalk, parking on the sidewalk, parking at a bus station and so on and so force. It should be understood that a user interface (UI) enables the configuration of the system to a particular set of violations and definition the triggering events that lead to an indication of a potential traffic or parking violation. It should be further understood that for each violation there may be one or more video clips and possibly one or more still images associated thereto.

According to the invention and the disclosed embodiments, the subsystem 10 communicates with a server 160 and a database 150 through a network 140 to provide information of a suspect violation which comprises at least one video clip and potentially one or more high resolution images, as well as other data such as time of day, date, location, type(s) of violation, etc. so that such information may be viewed by an enforcement officer. The network 140 may be wired or wireless, and may further be part of a local area network (LAN), wide area network (WAN), metro area network (MAN), a cellular network, the world wide web (WWW), the Internet, local storage to non-volatile media that is later transferred to the enforcement office for further processing and any other network and on-line or off-line data transfer, as well as combinations thereof.

The enforcement office may use an enforcement office unit (EOU) 170 to communicate through the network 140 with the server 160 and the database 150 for the purpose of retrieving suspect traffic or parking violations. The enforcement officer may view on the EOU 170 the video clip(s) and determine if a violation actually happened, and if so determine from the high resolution still images the precise information about the violating vehicle. Upon determination that a violation has occurred, a traffic citation (ticket) may be prepared accompanied with the necessary evidence which may now be stored for future use. In one embodiment of the invention, the person receiving the citation may receive a web link known as a universal resource locator (URL) to the video clip(s) and the high resolution image(s) so that the violator can view the evidence. In another embodiment of the invention, video clips may be recorded onto video media (such as a DVD) and mailed to the person receiving the citation. In yet another embodiment of the invention, the EOU 170 is further capable of receiving from the database 150 data respective of past violations associated with the offending vehicle and allowing the enforcement officer to generate a response that accounts with the violator's history. For example, and without limitations, an enforcement officer may determine that in view of the offender's history and kind of violation that a warning should be generated rather than a ticket.

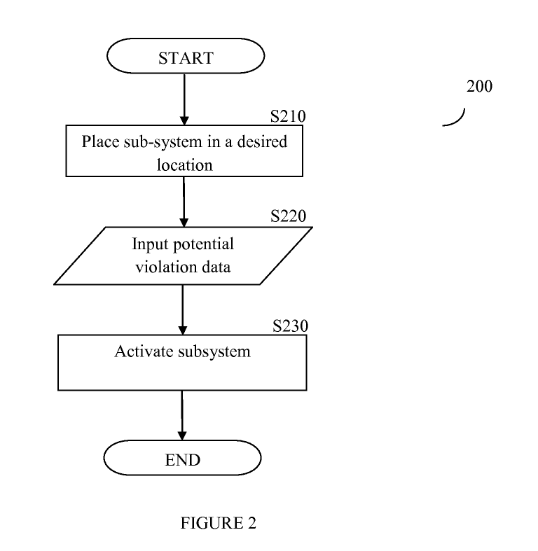

FIG. 2 depicts an exemplary and non-limiting flowchart 200 of the configuration of the subsystem 10. In S210, one or more video cameras and potentially one or more still cameras are placed in a desired location. In such a location the subsystem 10 should be able to cover an area where potential traffic violations occur. For example, the camera may be located where it is able to detect a no-cross separation line that may not be crossed. In S220 the subsystem 10 is configured, with respect to the viewing area of its one or more video cameras, to detect one or more potential traffic violations. Once configured, then in S230 the subsystem 10 is activated to be communicatively coupled to the server 160 and database 150 through the network 140, and thus be ready for capturing traffic violations. In one embodiment of the invention, the video clips are streamed from the camera (e.g., video camera 120-m) to the server 160, and in the server 160 the stream is recorded in consistent time chunks that have a cryptographic signature attached to them, and are not modified from this point onwards and by that guaranteeing authenticity.

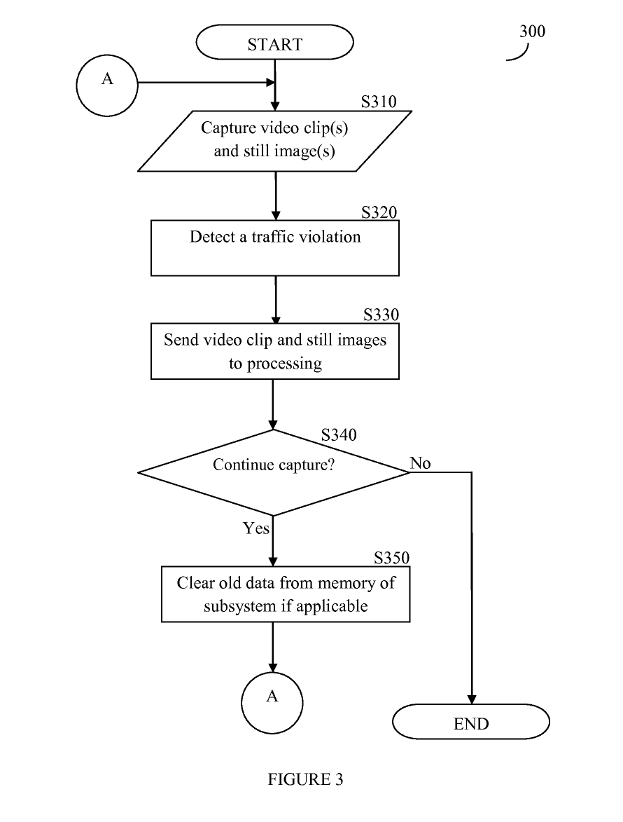

FIG. 3 depicts an exemplary and non-limiting flowchart 300 of the capture mode of a subsystem 10. In S310, the video camera(s) continuously inputs data to the subsystem 10 and capture high resolution evidence(s). In S320 the system 100 detects, by one or more of the processors of the subsystem 10, one or more traffic violations based on the configuration described in FIG. 2. In S330, if such a violation was detected, the subsystem 10 sends a video clip plus high resolution evidence to the server 160 for the purpose of storage of the potential traffic violation in the database 150. It should be noted, that once a confirmation is received that the information was properly stored in the database 150, the data in subsystem 110 may be erased thereby freeing memory, as noted herein below.

In S340, it is checked whether the subsystem 10 should continue capturing, and if so execution continues with S350; otherwise, execution terminates. In S350 it is determined if older data can be erased from the subsystem, 10 and if so data is erased prior to continuation with S310.

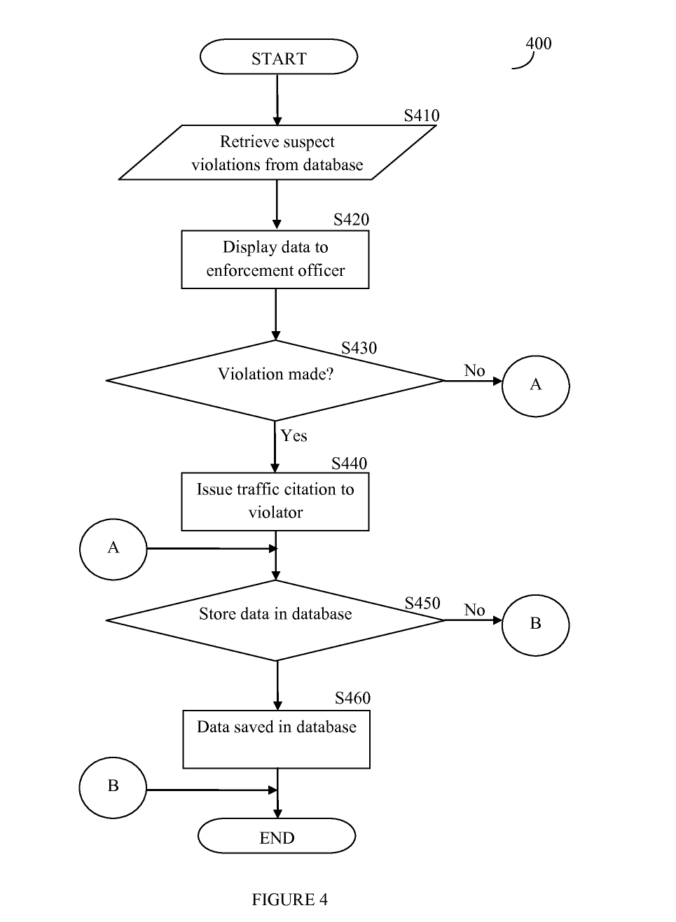

Reference is now made to FIG. 4 where an exemplary and non-limiting flowchart 400 of the citation mode of the system 100 with respect of the EOU 170 is shown. In S410, the EOU 170 retrieves information respective of a suspect traffic violation stored in the database 150. This may include one or more video clip(s) of the suspect violation, one or more still images respective thereof, and as further described hereinabove. In one embodiment of the invention, the still camera (e.g. camera 110-n) starts taking still images only after a violation is detected. In another embodiment of the invention, the still camera continuously takes still images and if a violation is detected during video clip analysis (real-time or off-line) the system 100 retains the corresponding still images. The information may further include data, such as the time and date of the violation, location, audio recordings as may be applicable. For example, in a mobile version of the system, an enforcement officer or a user of the system may record information relating to the violation observed.

In S420, the suspect violation is presented to a user, for example, an enforcement officer using the EOU 170. In S430 the user is prompted to decide if a violation actually happened based on both the one or more video clips and zero or more still images. If a violation is detected by the user then execution continues with S440; otherwise, execution continues with S450. In S440 a citation report (ticket) with respect of the traffic violation is issued by the user, e.g., the enforcement officer, to the violator. In S450, it is checked whether the user of the system 100 wishes to store the data provided for future use, for example in database 150, and if so execution continues with S460; otherwise, data is discarded and execution terminates. In S460 the clip and associated data is stored in database 150. Execution may continue therefrom with S410 if additional suspect violations exist or otherwise execution may terminate.

In one embodiment of the invention, the system 100 may also include components that are able to identify vehicle information such as, but not limited to, license plates, colors, make and models of the vehicles in a video clip frame or a high resolution image. Such an embodiment can use these components to annotate the video clip frames and/or the high resolution images. Such annotations may include, for example, pixel geometry of a license plate inside the video frame or high resolution image, and may also include a textual representation of the license plate that is generated by means of optical character recognition algorithms (OCR).

In yet another embodiment of the invention, the system 100 is mobile, for example, assembled on a patrolling vehicle wherein cameras can be assembled on at least one side of the patrolling vehicle. The system 100 may be capturing on a continuous basis or otherwise manually activated by a user through, for example, a user interface. Furthermore additional information may be added automatically from Global positioning System (GPS)/License Plate Recognition (LPR) systems, as well as notes and voice recordings.

All examples and conditional language recited herein are intended for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same or more general function, regardless of structure. For example, the still camera may be replaced by a 3D camera, a light field camera, a synthetic aperture camera or depth sensing camera. Similarly, the video camera may be replaced by the respective video equivalents listed for the still camera.

The various embodiments disclosed herein may be implemented as hardware, firmware, software, or any combination thereof. Moreover, the software is preferably implemented as an application program tangibly embodied on a program storage unit or non-transitory computer readable medium consisting of parts, or of certain devices and/or a combination of devices. A non-transitory computer readable medium is any computer readable medium except for a transitory propagating signal. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit, a DVD writer, and a printing unit.

A person skilled-in-the-art will readily note that other embodiment of the invention may be achieved without departing from the scope of the disclosed invention. All such embodiments are included herein. The scope of the invention should be limited solely by the claims thereto.

What we claimed is:

1. An apparatus for monitoring and reporting suspect traffic violations comprising:
at least one video camera for capturing a video clip of a suspect traffic violation by an offending vehicle;
a processor coupled to the at least one video camera, the processor configured to detect the suspect traffic violation based on a particular set of traffic violations and definitions of triggering events; and
an interface to a network for reporting the detected suspect traffic violation.

2. The apparatus of claim 1, wherein the suspect traffic violation comprises at least one of: a moving traffic violation and a parking traffic violation.

3. The apparatus of claim 1, further comprises:
at least one still image camera for capturing one or more still images of the offending vehicle in conjunction with the video clip.

4. The apparatus of claim 1, wherein the processor is further configured to identify vehicle information of the offending vehicle, wherein vehicle information includes at least one of: a vehicle license plate, a vehicle color, and a vehicle model.

5. The apparatus of claim 1, wherein the network is at least one of: a wireless network, a wired network, a local area network (LAN), a wide area network (WAN), a metro area network (MAN), a world wide web (WWW), and the Internet.

6. The apparatus of claim 1, wherein the reporting the suspect traffic violation comprises: sending the video clip of the suspect traffic violation by the offending vehicle to a server connected to the network.

7. The apparatus of claim 1, wherein the processor is further configured to produce one or more still images from a frame of the video clip.

8. The apparatus of claim 3, wherein the reporting the suspect traffic violation comprises: sending one or more still images of the offending vehicle to a server connected to the network.

9. The apparatus of claim 1, further comprises:
a user interface for configuration of the processor to define the particular set of violations and triggering events of the traffic violation;
the network; and
a server connected to the network, wherein the server configured to store at least one of a video clip of the suspect traffic violation by the offending vehicle, and one or more still images of the offending vehicle respective of the video clip of the suspect traffic violation by the offending vehicle in the database.

10. The apparatus of claim 9, wherein the processor is further configured to detect the suspect traffic violation based on one or more inputs received from a user by the user interface.

11. The apparatus of claim 10, further comprises:
a user terminal connected to the network and configured to access a database for retrieving the video clip of the suspect traffic violation by the offending vehicle, wherein the database stores the video clip.

12. The apparatus of claim 11, wherein the user terminal is further configured to generate a traffic citation responsive to a user input determining that the suspect traffic violation is valid.

13. The apparatus of claim 1, wherein the apparatus further provides at least one of:
a date of suspect violation, a time of suspect violation, a location of suspect violation, and a type of suspect violation.

14. A method for monitoring and reporting a suspect traffic violation, comprising:
capturing a video clip by a video stream of a video camera;
examining, by a processor, the video clip for identification of the suspect traffic violation based on preconfigured traffic violations and definitions of triggering events;
capturing violator identification evidence of an offending vehicle respective of the video clip when the suspect traffic violation has been determined; and
sending the video clip of the suspect traffic violation and the corresponding violator identification evidence over a network to a server.

15. The method of claim 14, wherein examining the video clip for identification of the suspect traffic violation further comprising:
receiving one or more inputs from by a user inputs.

16. The method of claim 14, further comprising:
storing the video clip of the suspect traffic violation in a database connected to the server.

17. The method of claim 16, further comprising:
retrieving the video clip of the suspect traffic violation and one or more corresponding still images for display on a user terminal, wherein the one or more still images are derived from the video clip or from a still image camera;
receiving from a user of the user terminal an indication of whether or not a real traffic violation has occurred with respect of the video clip of the suspect traffic violation and the one or more corresponding still images; and
generating a citation report respective of the video clip of the suspect traffic violation and the one or more corresponding still images when a real traffic violation has occurred.

18. The method of claim 17, wherein generating the citation report includes consideration of previous citations respective of the offending vehicle.

19. The method of claim 14, further comprising:
storing the video clip of the suspect traffic violation and the one or more corresponding still images and the citation report in the database when a traffic violation has occurred; and
removing from the database the video clip of the suspect traffic violation and the one or more corresponding still images when no traffic violation has occurred.

20. The method of claim 14, further comprising:
identifying the vehicle information of the offending vehicle, wherein vehicle information includes at least one of: a vehicle license plate, a vehicle color, and a vehicle model.

21. The method of claim 19, further comprising:
providing further information with respect of the offending vehicle, the further information including at least one of: the license plate recognition, the vehicle color, the vehicle model, a date of suspect violation, a time of suspect violation, a location of suspect violation, type of suspect violation, and annotates frames in video clips and high resolution images with information about the vehicles appearing in these frames and images.

22. A non-transitory computer readable medium having stored thereon instructions for causing the processor to execute the method according to claim 14.
